(19) United States
(12) Patent Application Publication
(10) Pub. No.: US 2015/0279424 A1
(43) Pub. Date: Oct. 1, 2015

(54) SOUND QUALITY OF THE AUDIO PORTION OF AUDIO/VIDEO FILES RECORDED DURING A LIVE EVENT

(71) Applicants: Neil C. Marck, Bainbridge Island, WA (US); Anthony E. Sharick, Bainbridge Island, WA (US)

(72) Inventors: Neil C. Marck, Bainbridge Island, WA (US); Anthony E. Sharick, Bainbridge Island, WA (US)

(21) Appl. No.: 14/671,381

(22) Filed: Mar. 27, 2015

Related U.S. Application Data
(60) Provisional application No. 61/971,412, filed on Mar. 27, 2014.

(51) Int. Cl. G11B 27/036

(52) U.S. Cl. CPC G11B 27/036

(57) ABSTRACT

A digital audio/video (AV) file, or media file (File A) recorded at a live event using a handheld AV recording device is uploaded by a client to an audio replacement service. The audio portion of the digital AV file is of relatively low quality compared to an audio file (File B) of the live event created by sound engineers or other event personnel during the live event. File B is also uploaded to the audio replacement service. A computing device at the audio replacement service automatically identifies a segment of File B corresponding to the audio portion of File A and then creates a new, enhanced digital AV file (File C) on which the low quality audio portion of File A is replaced with the corresponding high quality segment from File B. File C is then downloaded to the client.

### RELATED APPLICATIONS

This application is based on a prior copending provisional application, Ser. No. 61/971,412, filed on Mar. 27, 2014, the benefit of the filing date of which is hereby claimed under 35 U.S.C. §119(e).

### BACKGROUND

It has become very popular for members of an audience to a live event to record the live event using handheld audio/video (AV) recording device. For the purposes of this disclosure a handheld AV device may be any portable user device such as a handheld video recorder, a smartphone, tablet, or wearable device such as a watch or glasses with integrated AV recording capabilities that While some artists do not authorize such live recordings, others freely welcome the opportunity to become better known to the public by allowing the recordings, since the recorded digital AV media files will likely be widely distributed over social networks, such as FACEBOOK™, or via other Internet applications for distributing and sharing digital AV files, such as YOUTUBE™. These are simply two examples of such application, and there are clearly many other applications for sharing digital AV files.

For many performing artists, particularly those who are just starting on their careers, there is much benefit in having their talents more widely known, and they are happy to allow people in the audience to record and distribute digital AV files of the live events in which they are performing without claiming copyright infringement. For performing artists who are already well known and popular with the public, it may be desirable to provide some monetary incentive that would justify allowing members of the audience to record and share digital AV files of the live events in which they are performing.

Unfortunately, although the video quality of digital AV files produced by handheld AV recording devices has generally greatly improved in recent years, the sound portion of the digital AV files produced by these devices is typically of relatively lower quality, compared, for example to that of the audio files produced by the performer's sound engineer(s) or by live event support staff. The sound engineer(s) who work behind the scenes at such live events have the advantage of years of experience and training In addition, they use professional quality sound transducers that typically include one or more high quality wired or wireless microphones, as well as other types of acoustic pickups. These microphones or acoustic pickups are disposed near a performer's mouth, mounted on the performer's musical instrument, and/or positioned at other strategic locations not accessible by members of the audience. For example, high quality directional microphones can be employed on stage or off, to provide high quality sound recordings of performers and their instruments at live events. The professionally produced digital audio files for live events also will benefit from the use of a mixer or sound board that controls the relative levels of the various sound source signals when producing a digital audio recording of live event.

In contrast, portable or handheld AV recorders, such as the video cameras integrated within smart phones, camcorders, or other digital cameras having AV recording capabilities typically include relatively inexpensive integrated microphones that are disposed within the recording device. These microphones inherently are limited by being only as close to the performers or the instruments being played by the performers at a live event as the person in the audience holding the AV recording device. As a result, the quality of the sound recorded by the recording device is inherently limited and relatively low. When the digital AV files produced by such handheld AV recording devices are promulgated over the Internet, the poorer quality of the audio portion of these files detracts from the appreciation of performance by those playing the digital AV files. This relatively lower quality audio portion of such files can reflect poorly on the performers. Accordingly, the performers might prefer that the higher quality audio files produced by their sound engineer(s) or other live event staff were made available to the audience members and coupled to the video portion of the digital AV files of the audience-recorded AV files being distributed over the Internet. Similarly, the members of the audience at a live event would also clearly prefer to have the audio portion of the digital audio/video files that they record be of higher quality.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic isometric view of a live event showing how high quality digital audio files are created for use in replacing lower quality audio portions of digital audio/video (AV) files produced by members of the audience using handheld AV recording devices;

FIG. 2 is a schematic block diagram illustrating an exemplary embodiment for replacing a lower quality audio portion of a digital AV file with a higher quality audio portion;

FIG. 3 is a flowchart showing exemplary logic implemented by an audio replacement service that receives digital AV files from clients and replaces a lower quality audio portion of each such file with a corresponding higher quality audio portion, producing a new AV file that is then downloaded to the client;

FIG. 4 is a schematic diagram illustrating an exemplary embodiment in which digital AV files produced by handheld AV recording devices are uploaded to an audio replacement service over the Internet, so that corresponding digital AV files with higher quality audio portions can be returned to clients of the service;

FIG. 5 is a schematic block diagram of an exemplary digital AV file;

FIG. 6 is a schematic block diagram of an exemplary handheld AV recording device, such as a smart phone, that can be used to produce the digital AV files that are uploaded to the audio replacement service in FIG. 4;

FIG. 7 is a schematic block diagram illustrating how a relatively low quality audio portion of a digital AV file is matched to a corresponding segment of a high quality digital audio file that is then used to replace the lower quality audio portion in a new digital AV file transmitted to a client of the audio replacement service; and

FIG. 8 is a schematic block diagram of an exemplary computing device that can be employed for replacing the low quality audio portion of a digital AV file with a corresponding segment of a high quality digital audio file.

### DETAILED DESCRIPTION

Overview

This disclosure sets forth systems and methods for replacing the audio portion of an audio-video recording, the audio having relatively low quality, with a higher quality audio portion. Exemplary embodiments are illustrated with reference to the figures. Figures and disclosed embodiments are not limiting. It is intended that the figures and embodiments disclosed herein are to be considered illustrative rather than restrictive. No limitation on the scope of the technology that follows is to be imputed to the examples shown in the drawings and discussed herein.

Unlike the limitations imposed by audience-recorded AV files discussed above, this disclosure describes techniques, apparatuses, and systems capable of replacing the relatively lower quality audio portion of the digital AV files recorded by members of the audience at live events with higher quality digital audio files, such as those produced by the sound engineer(s) or other support staff at the live event, using professional sound recording equipment. Additionally, this disclosure describes using higher quality digital audio files produced using microphones and other acoustic pickup devices disposed in close proximity to the performers and/or their instruments at a live event.

Furthermore, some performers may agree to make the higher quality digital audio recordings produced during a live event available to members of the audience at no additional cost, still other performers may prefer to charge a fee for providing the higher quality digital audio files to members of the audience. This disclosure describes a system for managing the availability of the higher quality audio. Additionally, this disclosure describes identifying a portion of the high quality digital audio file that corresponds to the lower quality audio portion of AV file created by the audience member at the live event using a handheld AV recording device (i.e., the system synchronizes a corresponding segment of the high quality digital audio file with the video portion of the AV file).

Still further, a system is described whereby an online, or remote, service may combine the video portion of the digital AV files produced by members of the audience using handheld audio/video recording devices, with corresponding segment of the higher quality digital audio files that are recorded by professionals with professional equipment, during a live event.

In one embodiment, a plurality of users may record a live event using a handheld, or similar, AV recording device. Professional sound recording or AV recording devices may concurrently record a high quality version of the live event. The professional recordings may be further edited or modified by sound engineers at the live event or at a location remote from the event. Furthermore, editing may take place immediately following the recording, or at a point later in time. Both the professional recordings and the user recording(s) may be transmitted via wireless or wired communication networks to an audio replacement service and stored in a central database.

In further embodiments the audio replacement service may associate the received recordings with a particular live event based on the location of the transmission, or identifying information included in the transmission. For instance, the transmission may include a geotag or some other metadata associated with the file indicating a location where the AV file was created. The audio replacement service may then associate the location with a live event.

In some embodiments, the audio replacement service may analyze the sound recordings for characteristic features and log one or more timestamps associated with the one or more characteristic features. Still further, the audio replacement service may compare one or more recordings and synchronize the recordings based on the timestamps associated with one or more characteristic that are common between the files being compared.

The techniques, apparatuses, and systems described herein may be implemented in a number of ways. Example implementations are provided below with reference to the following figures.

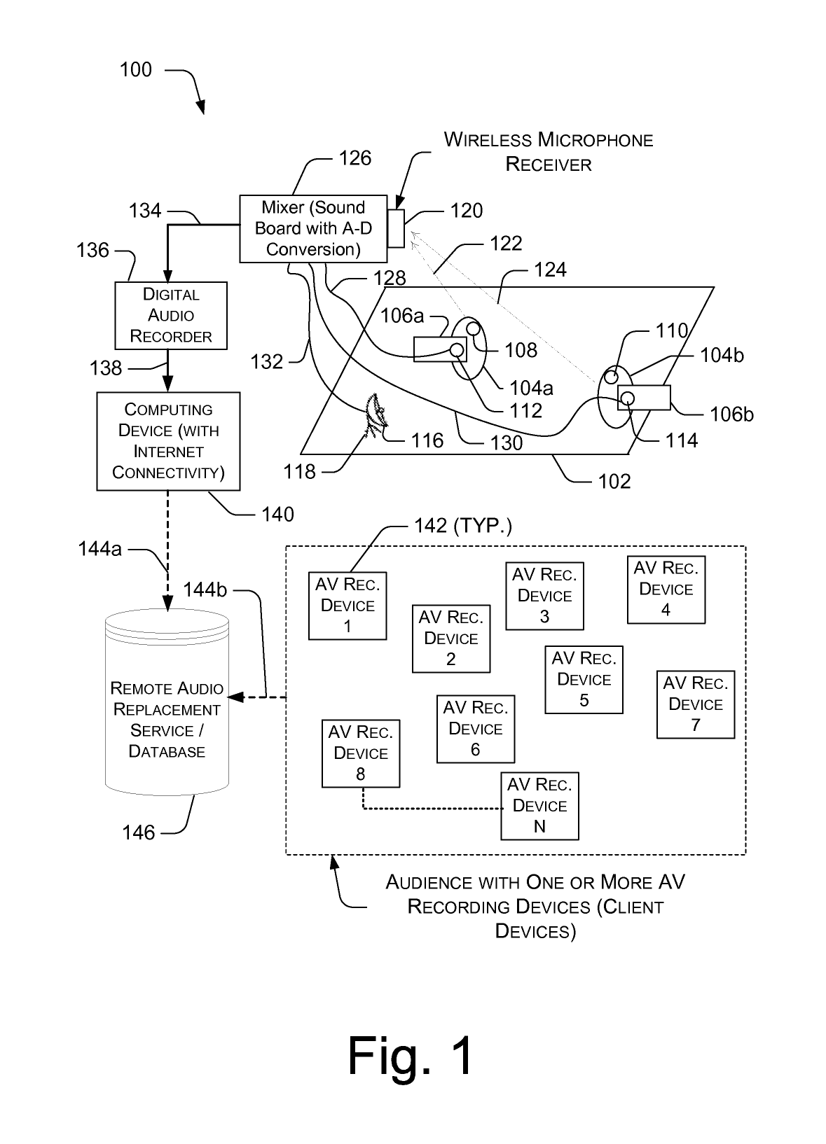

The schematic illustration shown in FIG. 1 illustrates an example of a live event 100 in a simplistic manner to show how the present concept can be employed. It should be noted that the example shown for live event 100 is not in any way intended to be limiting in regard to the style or presentation of the live event, the number or type of performers, musical instruments, microphones, acoustic pickup devices, sound recording equipment, audience members, or handheld AV recording devices used by members of the audience.

In exemplary live event 100, a performance is provided on a stage 102. The performance is provided by a first performer 104a and a second performer 104b . First performer 104a is performing with a musical instrument 106a , while second performer 104b is performing with a musical instrument 106b . These musical instruments may, for example, be acoustic or electric guitars, although many other types of musical instruments might instead be employed in the performance and provided either with a microphone or acoustic pickup. Further, in this example, first and second performers 104a and 104b are respectively provided with wireless microphones 108 and 110, which are disposed adjacent to the mouths (not shown) of the performers. Wireless microphones might be lapel mounted, headset mounted, or handheld. It will also be apparent that wired type microphones might instead be employed. Also, as shown in this example, first musical instrument 106a and second musical instrument 106b are respectively provided with acoustic pickups 112 and 114. The acoustic pickups directly sense the acoustical energy generated by the respective musical instruments (i.e., vibration rather than airborne sound) and produce corresponding analog output signals.

Wireless microphones 108 and 110 respectively transmit radio frequency signals 122 and 124 to a wireless microphone receiver 120 disposed at the side of or off stage 102. These radio frequency signals convey either analog or digital data corresponding to the sound energy picked up by the wireless microphones primarily in response to first performer 104a and second performer 104b talking or singing. While acoustic pickups 112 and 114 on the first and second musical instruments might also be of the wireless type, in this example, the analog output signals that the acoustic pickups produce are respectively conveyed over electrical leads 128 and 130 to a mixer or sound board 126 having analog-to-digital (A-D) conversion capability. Mixer 126 is used to control the relative levels of acoustic signals input on a plurality of different input channels, as will be well known to those of ordinary skill in the art. In addition, this simple example also includes a parabolic (or other type, such as a boom) directional microphone 116 that is supported on a tripod 118 and directed at either the first and second performers or some other sound source included in the performance. While only one such directional microphone is shown in this simple example, it will be apparent that the directional microphone may be omitted or more than one such directional microphone may be employed. Also, although not shown, an omni-directional microphone might also be provided, for example, to capture the applause and other sounds produced by the audience at the live event. Directional microphone 116 produces an analog signal corresponding to the sound energy that it receives from a specific direction that it is pointed, and the analog signal is conveyed to mixer 126 over an electrical lead 132. Wireless microphone receiver 120 also produces output signals corresponding to the sound data conveyed by wireless signals 122 and 124, and these output signals are also input to mixer 126.

Mixer 126 blends the various input signals according to the levels set for each input signal to it, converts analog input signals to digital signals, and produces multiple tracks of digital audio output signals that are input over electrical lead 134 to a digital audio recorder 136. The digital audio recorder stores a corresponding high quality digital audio file representing an audio recording of the performance sounds and other selected sounds (such as the audience applause, etc.) at live event 100. The digital audio file can then be conveyed over an electrical lead 138 to a computer 140 (or other computing device, such as a smart phone) with an Internet connection. This high quality digital audio file can further be uploaded by computer 140 to a remote audio replacement service (including a remote database) 146 via a wireless or wired communication device 144a , for example, by signals conveyed over a cable, telephone line, optical fiber, or via radio signals conveyed over a cell telephone system or other radio data network. Additionally, the 1-N audience members (i.e., client devices) may similarly send, via an Internet connection 144b , one or more client AV files to the remote audio replacement service 146.

As noted above, it is common for members of an audience at a live event to use handheld AV recording devices 142 to record performances. The handheld AV recording devices can, for example, and without any implied limitation, be an integrated video camera included in smart phone, or a camcorder, or other types of digital cameras having video recording capabilities. The microphone integrally provided in or with such handheld AV recording devices typically produces a digital AV file with an audio portion that is unacceptable. In contrast, the video portion of digital AV files produced by such handheld AV recording devices is typically of very good quality, with relatively high resolution, and may have been recorded through built-in optical zoom lenses. Considering that the built-in microphone is disposed at some distance from the performers on stage 102, and this distance is greater for members of the audience disposed further back from stage 102, it is easy to appreciate that the built-in microphone on the handheld AV recording device is able to only produce a low quality audio portion for the digital AV recording. The built-in microphone often tends to pick up more local sounds from the audience than sounds produced by the performers and their musical instruments on stage 102. Thus, members of the audience who record their own digital AV files may be dissatisfied with the audio portion of these files. Audience members may therefore prefer to access the much higher quality digital audio files that are output from digital audio recorder 136, since the quality of the audio recording that it creates greatly benefits from the “close mike” signals produced by wireless microphones 108 and 110, the audio signals produced by acoustic pickups 112 and 114, and the audio signal output from directional microphone 116. Furthermore, the digital audio file produced by digital audio recorder 136 also benefits from the skill and experience of the sound engineer(s) (not shown) or other professional persons employed by the performers or those presenting the live event, who setup the sound recording system and control mixer 126 and other aspects of the sound recording.

An objective standard can be applied in showing that the digital audio file produced by digital audio recorder 136 is of relatively “much higher quality” than the audio portions of the digital AV files produced by any of the handheld AV recording devices operated by the audience. The measure of the relative quality of a digital audio file or audio portion of a digital AV file is readily objectively determined, for example, by the following list of factors, which is intended to be exemplary and not limiting. The digital audio file produced by digital audio recorder 136 will clearly be of higher quality than the audio portions of the digital AV files produced by handheld AV recorders 142 at least due to the following characteristics of these files:
1. Signal-to-noise ratio (SNR) of the audio recording;
2. Placement of the microphone(s) used to produce the files relative to the desired sound source being recorded;
3. Frequency response of the microphone(s) or acoustic pickups used to produce the audio signal that is recorded in the digital audio recording;
4. Sensitivity of the microphone(s) or acoustic pickup(s) used to produce the audio signal(s) recorded;
5. Exclusion of background noise from the signals being recorded, including crowd noise, echoes and other reflected noise from the sound of the performance;
6. Controlled mixing of multiple channels of sound (i.e., multiple sound inputs) in the digital audio recording;
7. Inclusion of multiple tracks of audio in the digital audio recording, to produce stereo, or surround sound, rather than simply monophonic sound; and
8. Reduction in wind noise in the digital audio recording either electronically in mixer 126 or with a microphone wind screen (not shown) applied to wireless microphones 108 and 110.

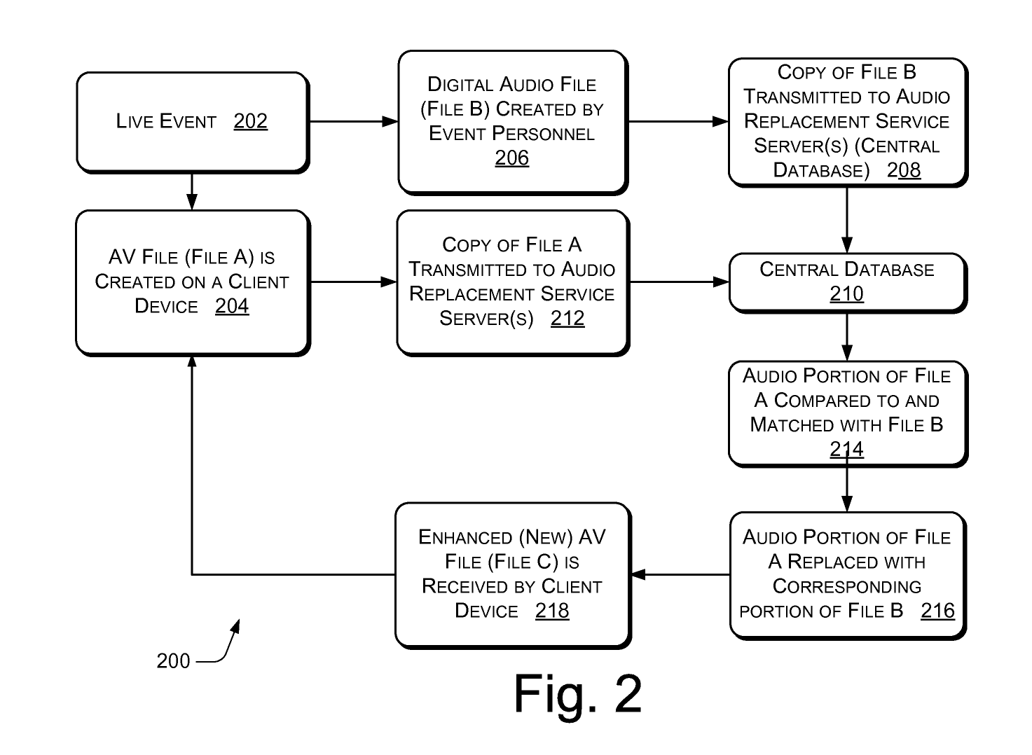

The present novel approach enables members of the audience at live event 100 to obtain the higher quality audio content from the digital audio file produced by digital audio recorder 136. This approach is illustrated for an exemplary embodiment by a schematic block diagram 200 in FIG. 2. A block 202 indicates that a live event has been presented to an audience. In a block 204, a digital AV file (File A) of the live event is created on an AV recording device that is operated by a member of the audience. During the live event a high quality digital audio file (File B) is also created by one or more sound engineers or other live event personnel at a block 206. As shown in a block 208 and a block 210, a copy of File B is transmitted to an audio file replacement service in accord with the present approach, for storage in a central database. The audio replacement service described below can be offered at no charge, or in return for person paying a higher price for a ticket to attend the live event, or for a nominal fee charged for each digital AV file submitted to the audio replacement service for replacement of a low quality audio portion of the digital AV file with a corresponding segment of the high quality digital audio file.

To take advantage of this service, a client of the service, who may be a member of the audience at the live event or someone who has access to the digital AV file recorded on a handheld AV recording device by a member of the audience, uploads a copy of File A to a central database associated with the audio replacement service, as shown in blocks 212 and 210. At the audio replacement service an audio portion of File A is compared to and matched with a corresponding segment of File B as shown in block 214. The audio replacement service may parse and analyze File A and File B, containing at least sound recordings, for characteristic features and the service may log one or more timestamps associated with the one or more characteristic features. Additionally, the audio replacement service may compare the one or more characteristic features identified in File A with the one or more characteristic features identified in File B, and timestamps associated therewith, to synchronize the recordings of File A and File B based at least in part on the timestamps.

Additionally, the audio replacement service may analyses a waveform associate with the sound recordings to identify one or more characteristic features associated with the sound recordings and corresponding timestamps. For instance, the audio replacement service may identify as a characteristic feature or fingerprint of File A, a portion of the waveform representing the audio of File A having on the signal-to-noise ratio greater than a threshold value. Similarly, the audio replacement service may have a database of characteristic features representing the audio of each high quality audio file (File B) in its database. The audio replacement service may identify the high quality audio file corresponding to File A based on one or more characteristic features. Still further, the audio replacement service may synchronize the two files (A and B, or A and the high quality audio file), by matching timestamps associated with the characteristic feature present in both files.

In order to synchronize File A with a portion of File B the audio replacement service may determine a global timestamp associated with the first frame of File A and the last frame of File A. For instance, the global timestamp may be included as metadata with File A and determined from the internal clock of the device used to record File A. The global timestamp may be, for example Greenwich Mean Time (GMT) associated with at least one frame of File A when the frame is recorded. Similarly, File B may also include an indication of a global timestamp associated with at least one frame of File B. File A and File B can therefore be synchronized based at least the GMT time of the at least one frame of File A and the frame of File B having the same GMT timestamp.

Next, in a block 216, the low quality audio portion of File A is replaced with the corresponding segment of File B based at least in part on the synchronization of the files. Finally, in a block 218, a resulting new, enhanced digital AV file (File C) that includes the original video portion and the new high quality audio segment from File B that corresponds to the audio portion of File A, is uploaded to the handheld AV recording device of the client (or to some other client device, such as client computer, laptop, smart phone, etc.). Additionally, all Files A, B, and C may be associated with the live event and stored in a central database of the audio replacement service. The client can then play File C and enjoy the original video recorded in File A, as well as the corresponding high quality digital audio segment from File B.

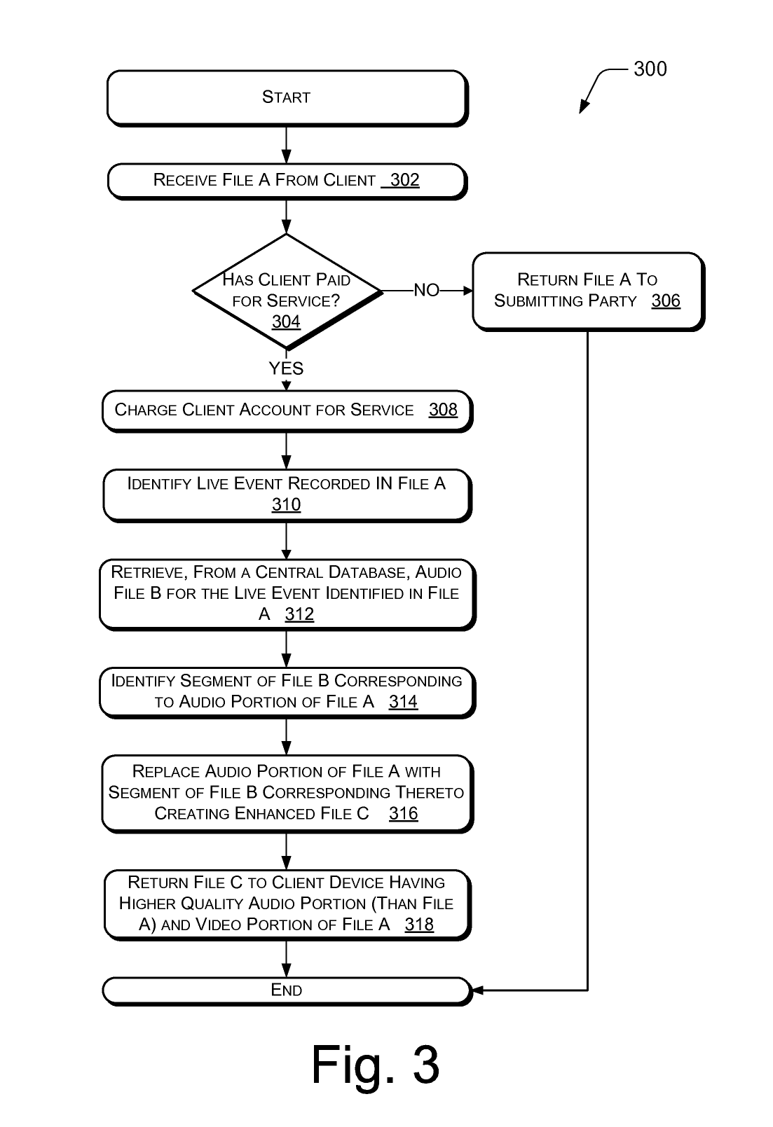

Further details of an exemplary embodiment for the audio replacement service carried out at blocks 214, 216, and 218 of FIG. 2 are illustrated in a flowchart 300 in FIG. 3. In a block 302, the audio replacement service receives File A from the client of the service. In an optional decision block 304 (which applies only if the audio replacement service is charging the client), a determination is made about whether the client has paid for the service. It should be noted that the client may pay with a credit card or some other mechanism such as PAYPAL™ at the time that File A is submitted to the service, or may have already paid for the audio replacement service (for example, with a higher ticket charge to attend the live event and also to have the audio portion of one or more digital AV files replaced with a high quality audio segment). In the latter case, the client will have been provided with proof of that payment, such as an account number, which can be input to a website for transmission to the audio replacement service. Additionally or alternatively, the live event may be preauthorized for the audio replacement service by an event organizer or the performer. Where the service is preauthorized the event organizer or performer may agree to pay for the audio replacement service based on a predetermined fee agreement. The audio replacement service may associate a received AV file from an audience member with a particular event based on metadata associated with the AV file, such as a geolocation or indication from the audience member included in the AV file submission.

Additionally, the audio replacement service may analyze one or more frames of the video recorded at the live event for one or more event identifiers. For instance image analysis may identify one or more trademarks associated with the producers of the event, or the performer or speaker of the event. The audio replacement service may thereby associate the AV file with the event corresponding to the one or more event identifiers.

If the client has not previously paid for the service or paid at the time of uploading File A to the service, or is not preauthorized, a block 306 provides for returning File A to the submitting party and procedure then terminates. However, if the client is paying contemporaneously with uploading File A to the audio replacement service, a block 308 provides for charging the client account for the audio replacement service being provided.

A block 310 then provides for identifying the live event recorded in File A. This step can be accomplished based on information solicited from the client during the process of uploading File A. Additionally, or alternatively, the live event may be determined automatically by using a computer or other computing device to scan the audio and/or video portion(s) of File A and identify characteristic features associated with the live event and/or the portion of the live event recorded in File A (e.g., a particular speaker, singer, logo or trademark in proximity to the subject of the AV file, etc.). Still further, File A may be associated with a live event based on a geolocation included in the metadata associated with File A. If the client has identified the live event, the automated scanning can determine the specific portion of the live event recorded on File A. Based on the determination of the specific live event and/or the portion of the live event recorded in File A, as indicated in a block 312, a computer at the audio replacement service can automatically retrieve digital audio File B for the live event from the central database where it was stored after being uploaded to the audio replacement service. Next, in a block 314, based upon the automated scan of File A, and a corresponding scan of File B, the computer or other automated device at the audio replacement service identifies a segment of high quality digital audio File B that corresponds to the audio portion of File A. In a block 316, the computer or other automated device replaces the low quality audio portion of digital AV File A with the segment of high quality digital audio File B to which it corresponds, producing a new File C. Finally, in a block 318, the computer at the audio replacement service automatically uploads the new File C to the client providing the client with the original video portion of digital AV File A coupled with the high quality segment of digital audio File B that was used to replace the original low quality audio portion of File A.

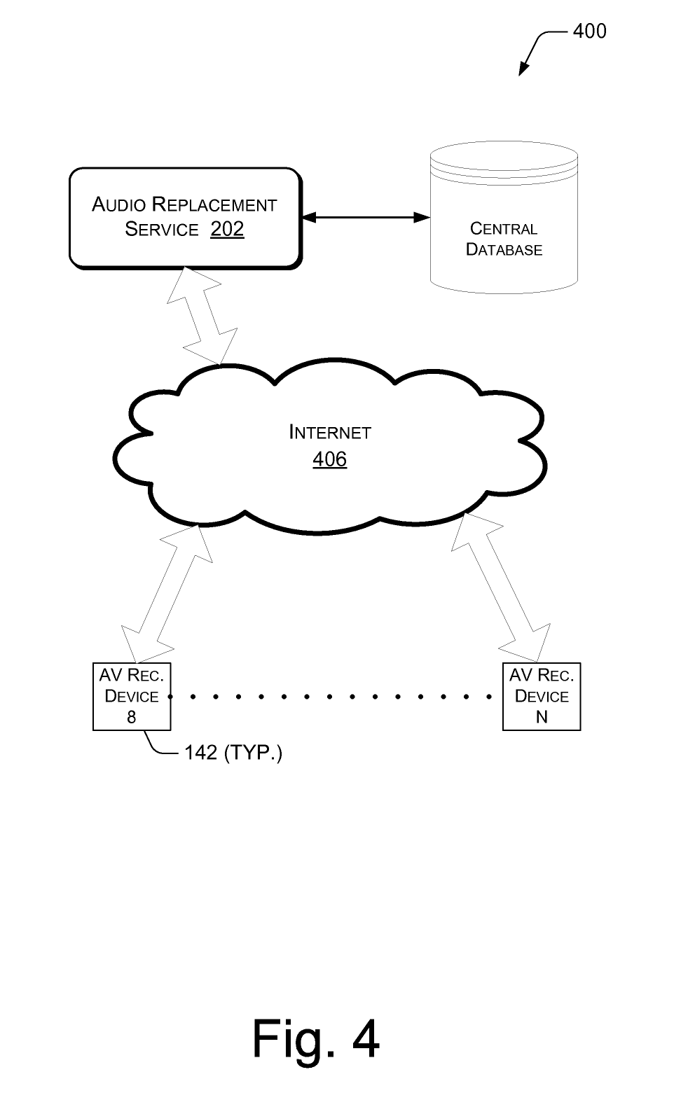

In FIG. 4, a schematic diagram 400 illustrates how each of the handheld AV recording devices 142, i.e., handheld recording devices 1-N, that were used to record digital AV files of live event 100 can communicate over data links 402 through 404 over Internet 406 and thus through a data link 408, with an audio replacement service 410. The audio replacement service includes a central database 412 in which the high quality digital audio File B recorded for the live event 100 may be stored. Audio replacement service 410 then carries out the functions described above in regard to FIG. 3 to replace the low quality audio portions of each of the digital AV files, i.e., File A for each such handheld AV recording device), with the corresponding segments of high quality digital File B. Each AV file recorded by individual clients may be unique (i.e., the files may be taken at different times and for different durations) even if they are recorded at the same event, however, the audio replacement service can autonomously identify the relevant portion of the live event from the client file, File A, and the corresponding segment of the high quality digital audio, File B, that should be used in creating a new File C for each different client by comparing the audio portion of File A with that of File B. Software for implementing this comparison is readily available for use with Apple Inc.'s IOS™, Microsoft Corporation's WINDOWS™, Android, and other operating system AV files, or can be programmed in house. Commercial AV editing tools that include the ability to compare AV files to identify corresponding portions and to replace an audio portion of an AV file with the corresponding segment of an audio file are available from Apple Inc., Wondershare, Adobe Systems Incorporated, and other software firms.

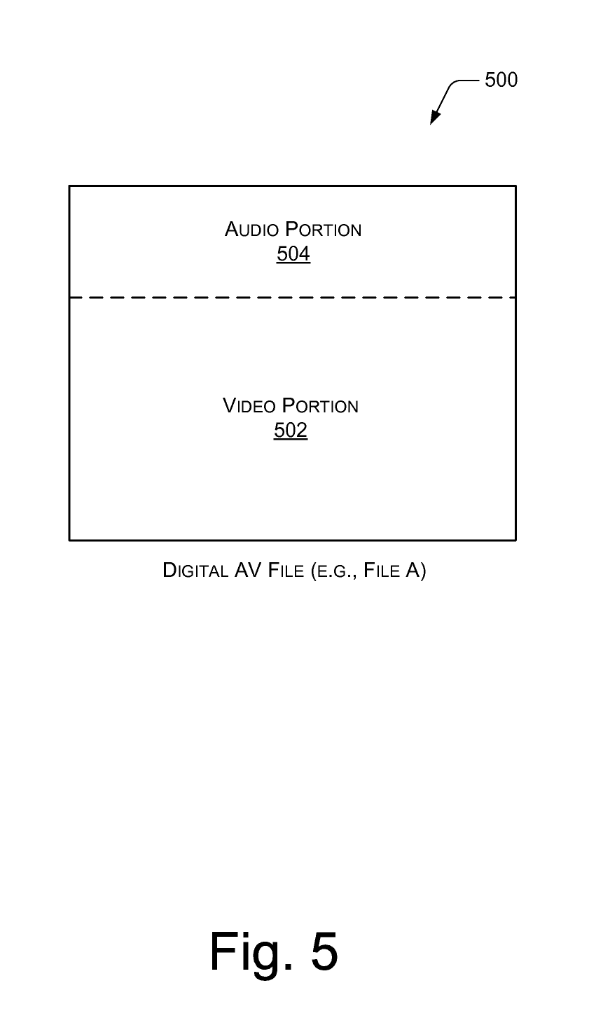

FIG. 5 illustrates a schematic view 500 of an exemplary digital AV file, such as File A, created by a handheld AV recording device 142. As noted above, such digital AV files typically include a video portion 502, and an audio portion 504.

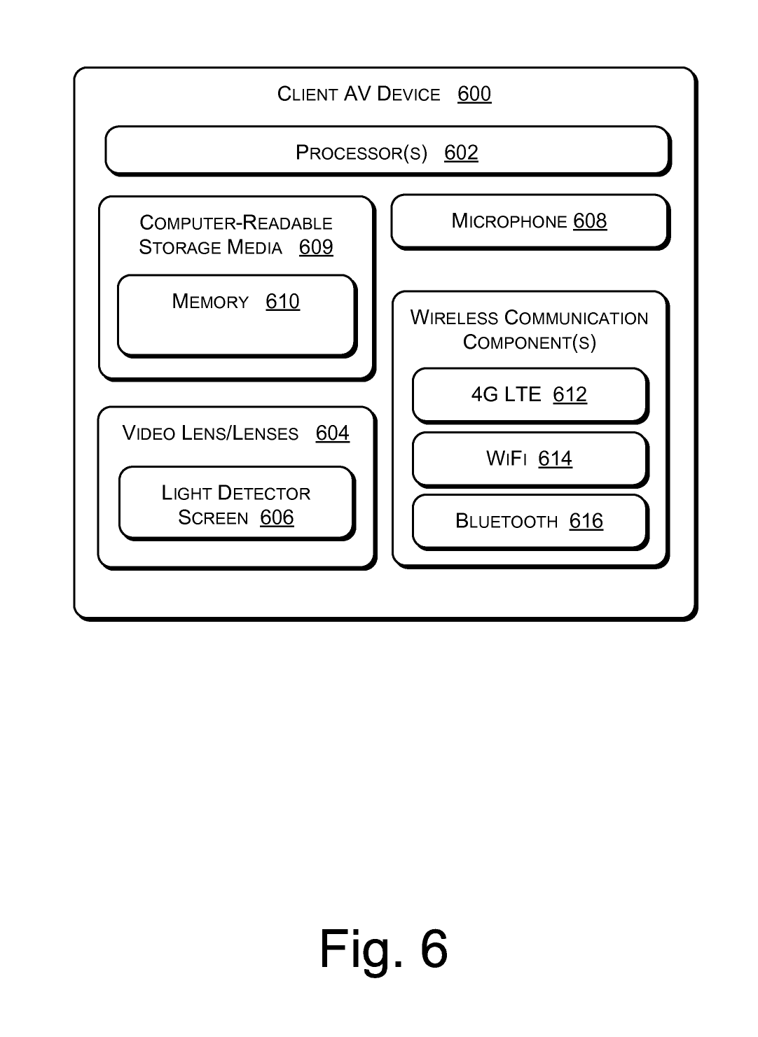

FIG. 6, a schematic block diagram of an exemplary client AV recording device 600 is shown. This example might be of a smart phone with an integrated video recording capability. In this example, client AV recording device 600 includes one or more processors 602, and a computer-readable storage media 609 that includes memory 610. The client AV device 600 may also include a video lens 604 that focuses incident light on a high resolution light detector screen 606. The video output signal from light detector screen 606 is stored in the memory 610, along with a digital audio signal produced by a built-in microphone 608. (Note that an analog-to-digital converter that is not shown would be included to convert an analog audio signal from microphone 608 to a digital signal.) The handheld AV recording device 602 can thus produce a digital AV file like that shown in FIG. 5. Also, optionally included in handheld AV recording device 602 is a 4G LTE (or other similar radio frequency system) transceiver 612, a WiFi transceiver 614, and/or a Bluetooth transceiver 616, any of which may be used for transmitting or uploading File A to the audio replacement service and for downloading or receiving File C from that service via an communication network..

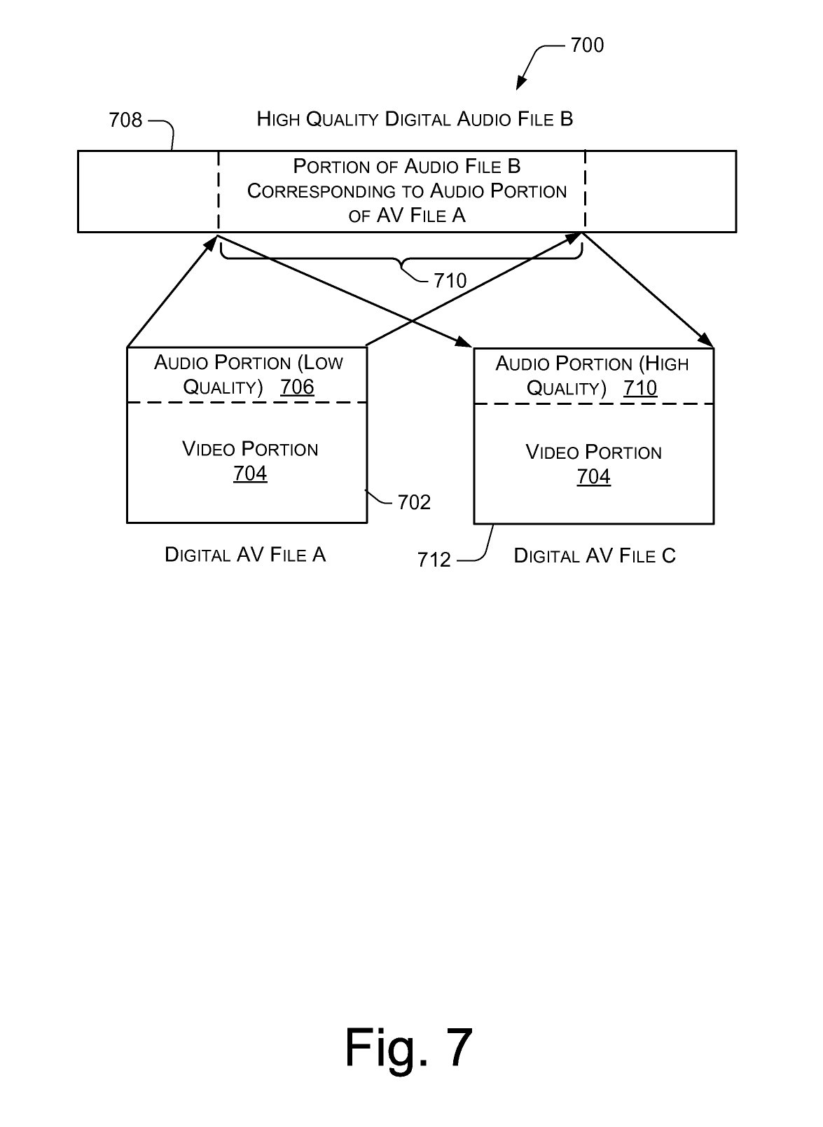

FIG. 7 is a schematic diagram 700 that illustrates a digital AV File A 702 with a video portion 704 and a low quality audio portion 706. A high quality digital audio File B 708 includes a segment 710 that corresponds to low quality audio portion 706 of digital AV File A. A digital AV File C 712 is produced by the audio replacement service that includes segment 710 of high quality digital audio File B 708 corresponding to low quality audio portion 706 of digital AV File A 702.

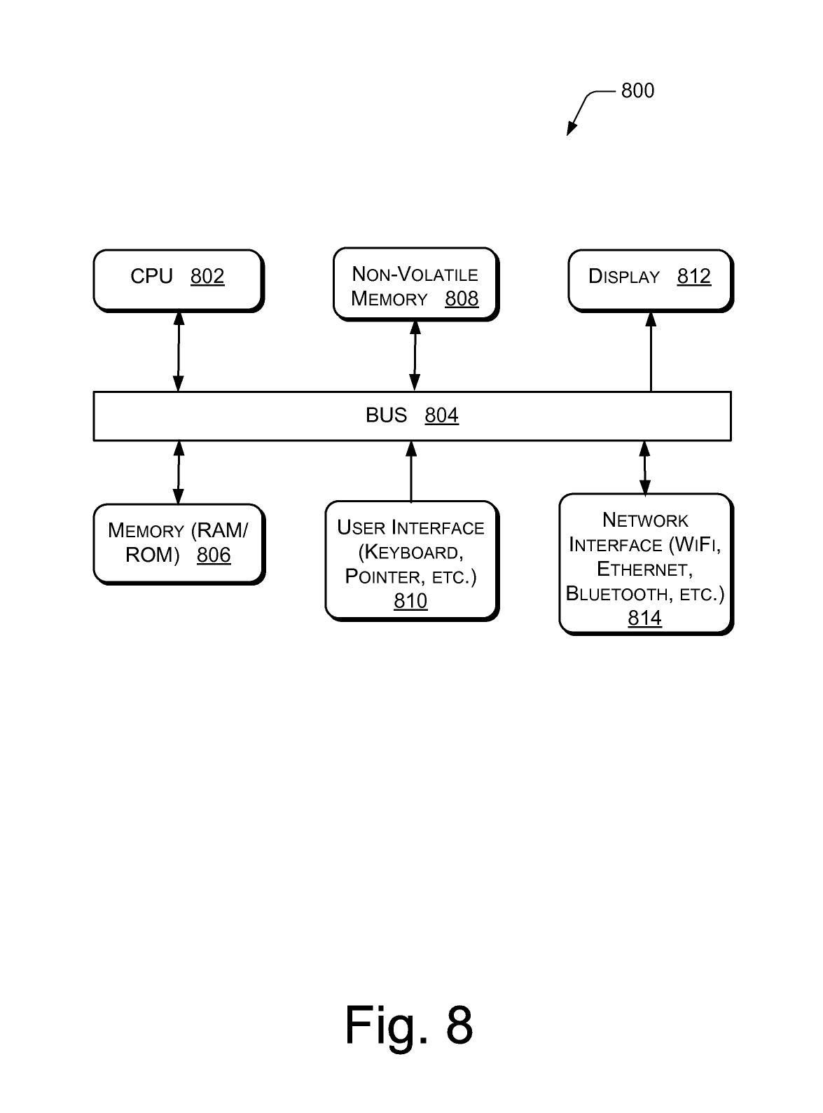

The functions performed by the audio replacement service, as discussed above, can be implemented automatically, without human intervention, using a computing device 800, an example of which is illustrated in the schematic block diagram of FIG. 800. Computing device 800 can, for example and without any implied limitation, be a desktop computer, a server, a laptop, a tablet, a personal data assistant (PDA), or any other type of logic device capable of carrying logical functions or executing software programs comprising machine language instructions. In the example illustrated in FIG. 8, a central processing unit (CPU) 802 is used to execute machine instructions that are loaded into a memory 806 and accessed over a data bus 804. These machine executable instructions may be stored in non-transitory form as one or more software programs or modules on a non-volatile memory 808, which can be, for example, a hard drive, optical disk and reader, or other type of memory device. The machine executable instructions may also be stored on either magnetic or optical disks that can be read, loaded into memory 806, and executed by CPU 802, or can be downloaded from a remote computer (not shown). Memory 806 can also store other machine executable instructions, such as those used for implementing an operating system, when executed by CPU 802, and may include both random access memory (RAM) and read only memory (ROM). A user interface 810 is coupled to data bus 804 and enables a user of computing device 800 to provide input to CPU 802 on a keyboard or keypad, and by using a pointing device, such as a mouse, trackball, touch pad, etc. to control a cursor used for selecting options and for moving graphic images presented on a visual display 812. A network interface 814 coupled to data bus 804 can enable bi-directional wired or wireless data communication in one or more data formats such as WiFi, Ethernet, Bluetooth, etc., for example. Network interface 814 can thus couple computing device 800 in data communication with a local area network (LAN), the Internet, a wide area network (WAN), and/or with other computing devices, including handheld AV recording devices used at live events to record at least portions of a performance or presentation. Computing device 800 can then be used for performing the functions of the audio replacement service described above in connection with FIG. 3 and might be a server that is coupled to Internet 406 and central database 412 (both shown in FIG. 4) via network interface 814.

It should also be noted that a client of the audio replacement service can upload File A to the audio replacement service using a computing device rather than the actual handheld digital AV recording device, since it may be preferable in some cases for a person attending the live event to transfer File A from their handheld AV recording device to a client computing device (not separately shown). Such a client computing device might be configured as shown in FIG. 8 and described above for computing device 800.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method for creating an enhanced audio-video (AV) file, comprising:
receiving, at one or more computers of an audio replacement service, a first AV file having a low quality audio component created by a client device;
associating a live event with the first AV file based at least in part on one or more characteristic features of the first AV file;
comparing the first AV file and a second, high quality AV file from the live event;
identifying at least a segment of the second AV file corresponding to the first AV file;
creating a third AV file by that includes at least the video portion of the first AV file and an audio portion of the at least the segment of the second AV file, wherein the video portion and the audio portion are synchronized; and
transmitting the third AV file to the client device.

2. The method according to claim 1, wherein the first AV file is recorded on a handheld device and the second AV file is recorded with a high quality audio recording system.

3. The method according to claim 1, further comprising:
scanning the first AV file for one or more characteristic audio or video features;
comparing the one or more characteristic features of the first AV file with one or more other AV files stored in a database; and
identifying, based on the one or more characteristic features, a second AV file having similar one or more characteristic features.

4. The method according to claim 3, wherein identifying the segment of the second AV file further comprises:
associating a timestamp with at least one frame of the first AV file;
determining, based at least in part on the timestamp, a corresponding frame of the second AV file; and
synchronizing the first and second AV file based at least in part on the timestamp.

5. A method according to claim 1, wherein the second AV file is identified based at least in part on the second AV file corresponding to the same live event that is associated with the first AV file.

6. An audio replacement system comprising:
one or more processors; and
memory to store computer-executable instructions that when executed cause the one or more processors to perform operations comprising:
storing, in the memory, one or more produced AV files, individual ones of the produced AV files including a video portion and an audio portion;
storing, in the memory, a client AV file received from a client device and including a client video portion and a client audio portion;
identifying a segment of at least one of the one or more produced AV files corresponding to the client AV file;
creating an enhanced AV file including at least the client video portion of the client AV file and the audio portion of the segment of the produced AV file; and
storing the enhanced AV file in the memory or a database.

7. The system of claim 6, the operations further comprising:
associating a live event with the client AV file based at least in part on one or more characteristic features identified in the client AV file; and
identifying, based on the associated live event, the at least one of the one or more produced AV files associated with the same live event.

8. The system of claim 6, wherein identifying a segment of the at least one of the one or more produced AV files further comprises:
determining a first global timestamp associated with a first frame of the client AV file and a second global timestamp associated with a last frame of the client AV file;
identifying, based at least in part on the first and second global timestamp, the segment of the at least one of the one or more produced AV files corresponding to the first and last frame of the client AV file.

9. The system of claim 6, wherein identifying a segment of the at least one of the one or more produced AV files further comprises:
determining a first waveform associated with a first audio portion of the client AV file and a second waveform associated with a last audio portion of the client AV file;
identifying, based at least in part on the first and second waveform, the segment of the at least one of the one or more produced AV files corresponding to first and last audio portion of the client AV file.

10. The system of claim 6, the operations further comprising transmitting the enhanced AV file to the client device.

11. The system of claim 6, the operations further comprising authorizing creation of the enhanced AV file based on at least one of:
a user associated with the client device;
a user profile maintained by the service provider and associated with the user or the client device;
a live event associated with the client AV file; or
a geolocation associated with the client AV file.

12. One or more non-transitory computer-readable media maintaining instructions executable by one or more processors to perform operations comprising:
recording a first media file during a live event and having at least a video portion;
transmitting, to one or more computers of an audio replacement service, a request to create an enhanced media file; and
receiving, from the one or more computers of the audio replacement service, at least a portion of a high quality media file.

13. The one or more non-transitory computer-readable media of claim 12, wherein the request includes a payment authorization.

14. The one or more non-transitory computer-readable media of claim 12, the operations further comprising transmitting an indication of the live event associated with the first media.

15. The one or more non-transitory computer-readable media of claim 14, wherein the indication of the live event is a geolocation associated with the live event.

16. The one or more non-transitory computer-readable media of claim 12, wherein the request includes an indication of a client or a user profile associated with the request.

17. The one or more non-transitory computer-readable media of claim 12, the operations further comprising:
receiving the high quality media file via a live wireless data stream; and
storing the streamed high quality media file.

18. The one or more non-transitory computer-readable media of claim 17, wherein the streamed high quality media file is a high quality audio file.

19. The one or more non-transitory computer-readable media of claim 18, wherein the video portion of the first media file is merged with the streamed high quality media file to create the enhanced media file.

20. The one or more non-transitory computer-readable media of claim 12, wherein the high quality media file is one of:
an enhanced media file, the enhanced media file including the video portion of the first video and a high quality audio portion synchronized with the video portion; or
a high quality audio portion corresponding the video portion of the first media file, and the video portion is synchronized and merged with the high quality audio portion to create an enhanced media file.
